(19) United States
(12) Patent Application Publication
(10) Pub. No.: US 2002/0113711 A1
(43) Pub. Date: Aug. 22, 2002

(54) Method for alerting a user locator entity of lost persons

(76) Inventors: Matthew Aaron Goldstein, Tempe, AZ (US); William Henry Conley III, Marana, AZ (US)

Correspondence Address: Matthew A. Goldstein, c/o William H. Conley, 33631 East Future Road, Marana, AZ, 85653, US

(21) Appl. No.: 10/032,792

(22) Filed: Dec. 28, 2001

Related U.S. Application Data
(60) Provisional application No. 60/269,504, filed on Feb. 16, 2001.

(51) Int. Cl. G08B 23/00

(52) U.S. Cl. 340/573.4; 340/573.1

(57) ABSTRACT

A method for alerting a user locator entity of data on lost persons comprising providing a check-in entity that stores user activity data including a check-in time and that transmits the user activity data to at least one user locator entity upon failure of the user to communicate with the check-in entity prior to the check-in time.

### REFERENCE TO RELATED APPLICATIONS

This is a continuation for provisional Patent Application No. 60/269,504 which was filed 02/16/2001.

### STATEMENT REGARDING FEDERALLY SPONSORED RESEARCH

This invention is not part of any federally sponsored U.S. Government research.

### Reference to Microfiche Appendix

Not applicable.

### BACKGROUND OF THE INVENTION

Every year, thousands of persons become lost in the course of travel and outdoor recreation activities. On land and at sea, there are thousands of search and rescue incidents resulting in thousands of lives saved and unfortunately, many lives lost. Of those lives lost, many die because notification of their lost status was made too late. Hence, there is a great need for systems assisting in the notification and location of persons at risk of becoming lost.

### BRIEF SUMMARY OF THE INVENTION

A method for alerting a user locator entity of data on lost persons comprising providing a check-in entity that stores user activity data including a check-in time and that transmits the user activity data to at least one user locator entity upon failure of the user to communicate with the check-in entity prior to the check-in time. Users of the method include, but are not limited to, travelers and outdoor recreation users.

### BRIEF DESCRIPTION OF THE DRAWINGS

FIG. 1 is flowchart illustrating the steps involved in one embodiment of the present invention; and

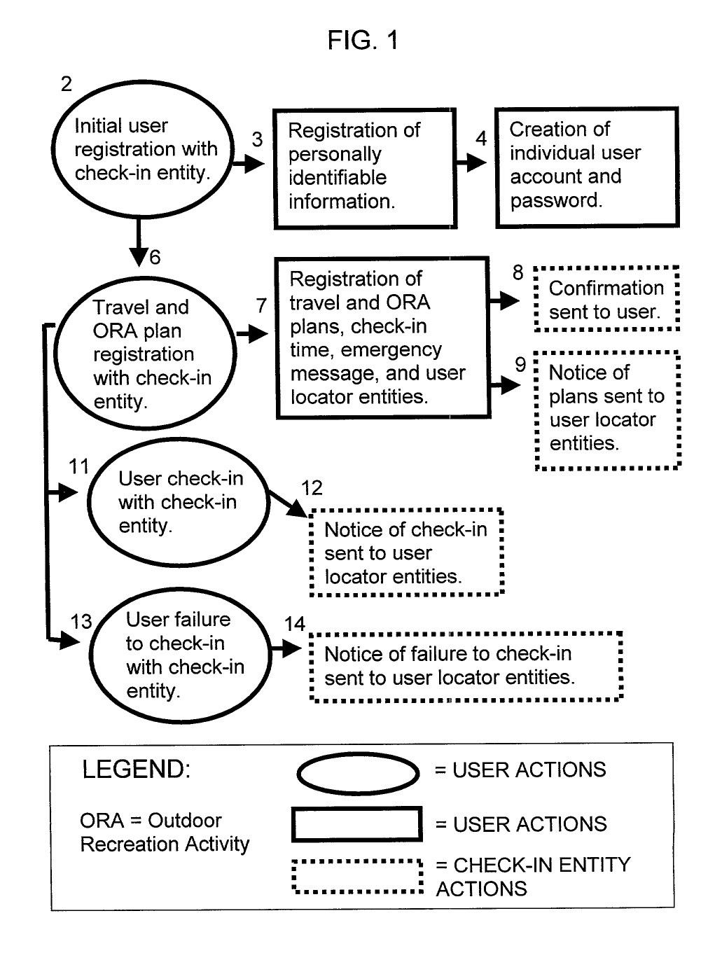

FIG. 2 is a flowchart illustrating the steps involved in subscription to one embodiment of the present invention.

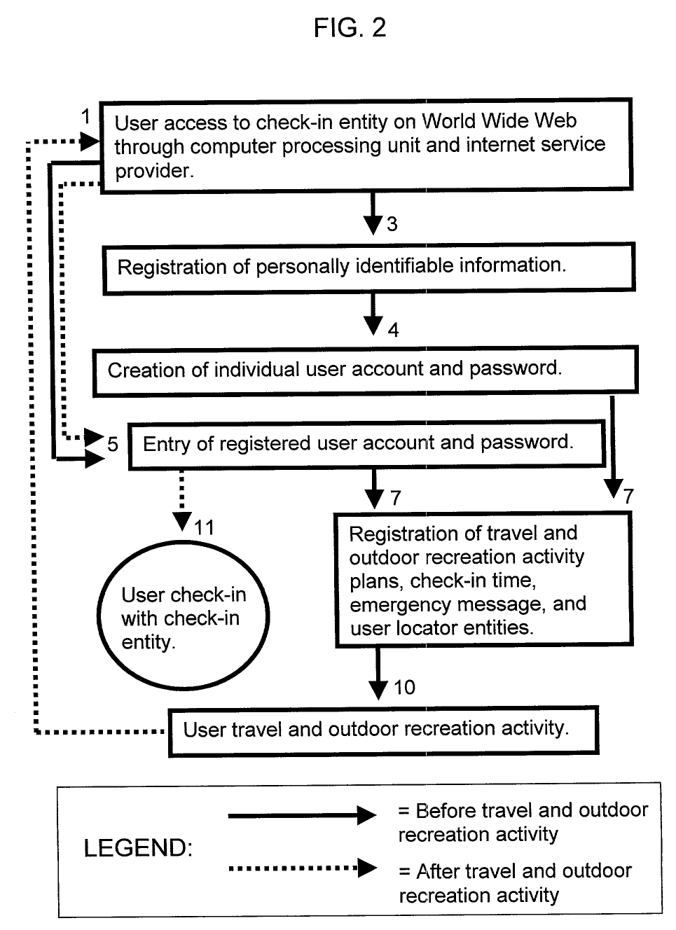

### DETAILED DESCRIPTION OF THE INVENTION

The invention relates generally to a method of transmitting information on a lost person. More specifically, the invention relates to a method of alerting a user locator entity of lost persons comprising providing a check-in entity that stores user activity data including a check-in time and that transmits the user activity data to at least one user locator entity upon failure of the user to communicate with the check-in entity prior to the check-in time.

The method is designed for use by persons engaged in activities where they may become lost. Such activities include but are not limited to travel and outdoor recreation activities. References to outdoor recreation activities may include but are not limited to: hiking, backpacking, wilderness expeditions generally, rock climbing, skiing, hunting, boating, scuba diving, and recreational flying.

The method is designed to supplement other emergency notification systems currently in place and to assist search and rescue measures by alerting family, friends, public safety officials, and other entities of a users failure to return from travel, outdoor recreation activity or other activity and by providing the detailed information necessary to assist rescuers in finding the user's location.

The term “lost person” defines a status wherein no source external to the person is aware of the person's location. Thus, by definition, the requirement that a source external to the lost person detect the lost person's status and location does little in the way of solving the problem. Moreover, it is the fact that a source external to the lost person does not detect the lost person's status as lost that is the problem. Further, when noticed, prompting from an external source to a centralized database to transmit information on the missing person is a duplication of tasks that consumes valuable time. Additionally, the subsequent transmission of information that a person is lost without the detailed information necessary to assist rescuers in ascertaining the lost person's location merely notifies of a status and does little in the way of solving the problems inherent in that status (i.e., the person will remain a lost person until information is provided that assists in their location so that they may become found). What is needed is a method that does not require detection and notification of the lost person's status by an external source and that provides detailed information concerning the lost person's travel and outdoor recreation activity plans.

Advantageously, the system is a first in line notification system and resolves problems inherent in other emergency notification systems that are secondary and dependent on notification of a lost or missing person's status from some outside or foreign source before they can disseminate the lost or missing person's personally identifiable information. Additionally, many of these prior systems do not store and disseminate detailed descriptions of the lost or missing persons travel, outdoor recreation activity or other activity plans. The present system stores and disseminates this information.

The term “check-in entity” defines any device, service or person that serves to receive, store, and transmit communications and other data to user locator entities. Examples of check-in entities include, but are not limited to, databases on computers generally, site services on the World Wide Web, and Local Area Networks.

The term “user locator entity” defines any device, service, or person that serves to receive a communication. Examples of user locator entities include, but are not limited to, computers generally, electronic mail addresses accessible on the World Wide Web or Local Area Network, electronic paging devices, alphanumeric paging devices, and telephone operators.

In accord with one aspect of the invention, the method receives, stores, and electronically transmits said information from a web server onto the World Wide Web accessible via the Internet. The Internet is an international network of interconnected computers. One category of communication over the Internet is the World Wide Web, which allows users to search for and retrieve information stored in remote computers, as well as, in some cases, to communicate back to designated sites. This method enables a larger user group access and use of the method.

As another respect, the method receives, stores, and electronically transmits said information from a server on a Local Area Network. A Local Area Network is a network of interconnected computers that spans a relatively small area. Most of these networks are confined to a single building or group of buildings. However, one Local Area Network can be connected to other Local Area Networks over any distance via telephone lines and radio waves. While permitting access to a smaller user group than the World Wide Web, Local Area Networks enable individual entity monitoring and special purpose utilization of invention.

Use of the terms World Wide Web and Local Area Network correspond to the method's use of a database system linked to an Internet or Intranet site respectively.

In accord with several aspects of the invention and in an embodiment, users initially access the check-in entity on the World Wide Web through a computer processing unit and internet service provider (1) and register with the check-in entity prior to travel or outdoor recreation activity plans (2). During this initial step, users register personally identifiable information including hair color, eye color, height, and weight (3). Preferably, users may also attach files in .jpg, gif, tif, or other graphic formats to the emergency message. Further preferable, each user will create an individual account by entering a username and password (4).

When the user plans travel and outdoor recreation activity, they access the check-in entity (1) and enter their username and password (5). They then register their specific travel or outdoor activity plan information with the check-in entity (6) Preferably, this information includes an emergency message to be sent, the date the user plans to leave, the date and time they are scheduled to return home, and the user locator entities for the user's emergency message to be sent to in the event they fail to check in with the check-in entity by the scheduled time of return (7).

After completion of the specific travel, outside activity or other activity information entry, the check-in entity will confirm the user's data before acceptance via a confirmation message that is sent to the user's electronic mail address (8). As another respect, the system will also send a notice to the user locator entities registered by the user, notifying the recipients of the user's plans (9). The user then engages in the travel and outdoor recreation activity (10).

When the user returns from the activity, they access (1) and check in with the check-in entity (11) and the check-in entity automatically sends a message that the user has returned to the user locator entities the user registered with the check-in entity (12). If the user does not check in with the check-in entity before the scheduled return home time (13), the emergency message the user composed is automatically sent to the user locator entities the user registered with the check-in entity (14).

The invention has been described in detail with particular reference to an embodiment thereof, but it will be understood that the invention is capable of other and different embodiments. As is readily apparent to those skilled in the art, variations and modifications can be affected in the spirit and scope of the invention. Accordingly, the foregoing written description and specification is for illustrative purposes only, and does not in any way limit the invention, which is defined only by the claims.

What is claimed is:

1. A method for alerting a user locator entity comprising:
providing a check-in entity;
storing user activity data, wherein the user activity data includes a check-in time; and
transmitting the user activity data to at least one user locator entity upon failure of the user to communicate with the check-in entity prior to the check-in time.

2. The method of claim 1, wherein the user activity data comprises an itinerary of the user prior to the check-in time.

3. The method of claim 1, wherein the user activity data comprises travel and outdoor recreation activity.

4. The method of claim 1, wherein at least one user locator entity comprises an alphanumeric pager.

5. The method of claim 1, wherein at least one user locator entity comprises an electronic mail address.

6. The method of claim 1, wherein at least one user locator entity consists of a computer.

7. The method of claim 1, wherein the user activity data is stored to and transmitted by at least one check-in entity located on a computer.

8. The method of claim 1, wherein the user activity data is stored to and transmitted by at least one check-in entity located on a site service on the World Wide Web.

9. The method of claim 1, wherein the user activity data is stored to and transmitted by at least one check-in entity located on a Local Area Network.

10. The method of claim 1, further comprising:
user activity data comprising an itinerary of the user prior to the check-in time; and
user activity data comprising travel and outdoor recreation activity; and
at least one user locator entity comprising an electronic mail address; and
user activity data that is stored to and transmitted by at least one check-in entity located on a site service on the World Wide Web.

11. A computer-readable medium containing computer instructions for instructing a processor to perform a method of alerting a user locator entity, the instructions comprising:
providing a check-in entity;
storing user activity data, wherein the user activity data includes a check-in time; and
transmitting the user activity data to at least one user locator entity upon failure of the user to communicate with the check-in entity prior to the check-in time.

12. The method of claim 11, wherein the user activity data comprises an itinerary of the user prior to the check-in time.

13. The method of claim 11, wherein the user activity data comprises travel and outdoor recreation activity.

14. The method of claim 11, wherein at least one user locator entity comprises an alphanumeric pager.

15. The method of claim 11, wherein at least one user locator entity comprises an electronic mail address.

16. The method of claim 11, wherein at least one user locator entity consists of a computer.

17. The method of claim 11, wherein the user activity data is stored to and transmitted by at least one check-in entity located on a computer.

18. The method of claim 11, wherein the user activity data is stored to and transmitted by at least one check-in entity located check-in entity located on a site service on the World Wide Web.

19. The method of claim 11, wherein the user activity data is stored to and transmitted by at least one check-in entity located on a Local Area Network.

20. The method of claim 11, further comprising:
user activity data comprising an itinerary of the user prior to t he check-in time; and
user activity data comprising travel and outdoor recreation activity; and
at least one user locator entity comprising an electronic mail address; and
user activity data that is stored to and transmitted by at least one check-in entity located on a site service on the World Wide Web.
